(19) United States
(12) Patent Application Publication
(10) Pub. No.: US 2024/0349404 A1
(43) Pub. Date: Oct. 17, 2024

(54) APPARATUS AND METHOD FOR HEATING AT PYROLYTIC TEMPERATURES USING MICROWAVE RADIATION

(71) Applicant: Aspen Aerogels, Inc., Northborough, MA (US)

(72) Inventors: Nicholas Leventis, Worcester, MA (US); Sean Depner, Worcester, MA (US); Joshua Bartels, Northborough, MA (US)

(73) Assignee: Aspen Aerogels, Inc., Northborough, MA (US)

(21) Appl. No.: 18/754,851

(22) Filed: Jun. 26, 2024

Related U.S. Application Data
(63) Continuation of application No. PCT/IB2023/052835, filed on Mar. 22, 2023.
(60) Provisional application No. 63/323,793, filed on Mar. 25, 2022.

(51) Int. Cl. H05B 6/80; C01B 32/05

(52) U.S. Cl. CPC H05B 6/80; C01B 32/05; C01P 2002/82; C01P 2004/03; C01P 2006/10; C01P 2006/12

(57) ABSTRACT

Heating and processing a polymeric material is achieved using a microwave absorbing structure that defines a processing chamber to receive the polymeric material (e.g., one or more precursors to form a polymer). A microwave radiation source directs microwave radiation to the microwave absorbing structure, which absorbs the radiation and can process the material.

### CROSS-REFERENCE TO RELATED APPLICATIONS

This application is a continuation of International Application Number PCT/IB2023/052835, filed Mar. 22, 2023, and which claims priority to U.S. Provisional Application Ser. No. 63/323,793 entitled “APPARATUS AND METHOD FOR HEATING AT PYROLYTIC TEMPERATURES USING MICROWAVE RADIATION” filed Mar. 25, 2022, each of which are incorporated herein by reference in their entireties.

### TECHNICAL FIELD

The present disclosure relates generally to high-temperature processing of a material using a microwave energy source. In particular, the present disclosure relates to devices and methods for the pyrolytic heating of a material using a microwave oven. For example, the technology of the present disclosure can be used for the carbonization of polymeric particles using a conventional microwave oven. The polymeric particles can be porous, and especially in the form of an aerogel.

### BACKGROUND

Aerogels are low-density, open-pore, solid materials that include a porous network of micro-sized and meso-sized pores (i.e., pores with sizes that extend from the micro-to the macro-size regime). When formed of organic materials—such as phenolic polymers (e.g., resorcinol-formaldehyde (RF), phloroglucinol furfuraldehyde (PF), polybenzoxazine, polyacrylonitrile (PAN), polyimide (PI), polyurethane (PU), polybutadiene, polydicyclopentadiene, and precursors or polymeric derivatives thereof)—the aerogel may be carbonized (e.g., by pyrolysis) to form a carbon aerogel, which can have properties (e.g., pore volume, pore size distribution, skeletal morphology, etc.) that differ from or overlap with those of their precursors, depending on the precursor materials and methodologies used. To process the precursors (e.g., to carbonize the precursors to form the carbon aerogel), high temperatures (e.g., typically over 500° C., such as 600° C., 700° C., 1000° C., 1400° C.) are used to pyrolyze the material. Generation of such high temperatures requires a large energy consumption and can be labor intensive in terms of ramping a high temperature oven up to temperature.

### SUMMARY

In general, the present technology is directed to apparatus and methods for thermal processing of a material. More specifically, the present technology provides apparatus and methods that utilize microwave energy (e.g., a conventional microwave oven) to process materials (e.g., polymeric materials) at high temperatures. In examples, the present technology is directed to processing solid polymeric materials, such as aerogels, from one form to another, utilizing microwave energy. In some examples, a microwave oven is utilized to carry out carbonization of a polymeric aerogel. While the present technology is directed to processing material using microwave radiation, there is no requirement or necessity for the processed material to absorb microwave radiation.

A first general aspect of the present technology relates to an apparatus for heating a material. The apparatus includes a microwave absorbing structure defining a processing chamber to receive the material; and a microwave radiation source (e.g., a conventional microwave oven) that generates microwave radiation in the direction of the microwave absorbing structure to thermally active polymer processing of the material.

Examples of the above aspect of the technology can include one or more of the following features. In an example, the microwave absorbing structure comprises a sample holder at least partially surrounded by a microwave radiation absorbing material. A non-limiting list of possible microwave radiation absorbing materials includes nickel oxide, silicon carbide, yttria-stabilized zirconia, iron oxide, melamine, carbon, and combinations thereof. In some examples, the sample holder and the microwave radiation absorbing material are embedded within a thermally insulating porous ceramic (e.g., alumina). In certain examples, the material to be heated or processed comprises one or more carbon precursors. The apparatus, in some examples of the technology, further includes an inert gas source in fluid communication with the microwave radiation source to surround the microwave absorbing structure in an inert gas atmosphere. Some examples further include a microwave waveguide to direct the microwave radiation to the microwave absorbing structure.

Another aspect of the technology is directed to a method of processing a polymeric material (e.g., carbonizing the polymeric material). The method includes positioning the polymeric material within a microwave absorbing structure and directing microwave radiation from a microwave radiation source to the microwave absorbing material to process the polymeric material.

Examples of the above aspect may include one or more of the following features. In some examples, directing microwave radiation from a microwave radiation source to the microwave absorbing material to process the polymeric material includes applying a microwave radiation source between 5 minutes to 15 minutes, between 10 minutes to 15 minutes.

In an example, the microwave absorbing structure comprises a sample holder at least partially surrounded by a microwave radiation absorbing material. A non-limiting list of possible microwave radiation absorbing materials includes nickel oxide, silicon carbide, yttria-stabilized zirconia, iron oxide, melamine, carbon, and combinations thereof. In certain examples, the sample holder is made of ceramic or carbon. In some examples, the sample holder and the microwave radiation absorbing material are embedded within a thermally insulating porous ceramic (e.g., alumina). In certain examples, the polymeric material comprises an aerogel, such as, for example, a polyamic acid aerogel, a polybenzoxazine aerogel, a phenolic resin aerogel, an isocyanate derived aerogel, a hydrocarbon aerogel, a biopolymer aerogel, or an inorganic aerogel. Some examples of the above method may further include providing an inert gas atmosphere to the microwave absorbing structure using an inert gas source in fluid communication with the microwave radiation source. Certain examples of the method can further include directing the microwave radiation to the microwave absorbing structure using a microwave waveguide.

In one aspect, provided herein is a method of processing a polymeric material. The method includes positioning the polymeric material within a sample holder; and applying microwave radiation from a microwave radiation source to process the polymeric material. In some examples, the polymeric material is partially carbonized prior to applying microwave radiation. In one example, the partially carbonized polymeric material is obtained by applying heat in a conventional oven for a predetermined time. In some examples of this aspect of the technology, the predetermined time is between 1 hour to 3 hours. In some examples, the polymeric material includes a layer of microwave absorbing material (e.g., carbon black) on a surface. For example, a carbon layer (e.g., carbon tape) may be applied to the surface of the polymeric material prior to applying microwave radiation. In another example, a flame or laser may be applied to the surface of the sample to create a microwave susceptible material (microwave absorbing material) on the surface. In some examples, microwave radiation from a microwave radiation source is applied for between 5 minutes to 15 minutes.

The techniques disclosed herein can provide one or more of the following advantages. In some examples, processing materials using the microwave absorbing structure and microwave radiation is significantly faster than conventional heating processes. In certain examples, processing materials using the microwave absorbing structure and microwave radiation is significantly less expensive than conventional heating processes. In addition, customized or tailored processing (e.g., temperature) can be provided without having to condition heating elements (e.g., ramp up or ramp down). Furthermore, the use of the microwave absorbing structure to heat a sample material allows for the processing of materials using a conventional microwave oven, rather than an industrial type microwave radiation source, or a conventional electric furnace.

These and other features, aspects, and advantages of the disclosure will be apparent from a reading of the following detailed description together with the accompanying drawings, which are briefly described below. The invention includes any combination of two, three, four, or more of the above-noted examples as well as combinations of any two, three, four, or more features or elements set forth in this disclosure, regardless of whether such features or elements are expressly combined in a specific example description herein. This disclosure is intended to be read holistically such that any separable features or elements of the disclosed invention, in any of its various aspects and examples, should be viewed as intended to be combinable unless the context clearly dictates otherwise.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

In order to provide an understanding of examples of the technology, reference is made to the appended drawings, which are not necessarily drawn to scale. The drawings are exemplary only and should not be construed as limiting the technology. The disclosure described herein is illustrated by way of example and not by way of limitation in the accompanying figures.

FIG. 1 illustrates a number of separate and stackable components of a sample chamber that can be used as a pyrolysis system, according to an example of the present disclosure.

FIG. 2 illustrates an example crucible within an insulating base, according to an example of the present disclosure.

FIG. 3 illustrates a machined carbon tile being placed within the crucible of FIG. 2, according to an example of the present disclosure.

FIG. 4 illustrates a machined carbon cylinder placed around a bottom portion of a sample holder, according to an example of the present disclosure.

FIG. 5 illustrates a second machined carbon cylinder placed around a top portion the sample holder, according to an example of the present disclosure.

FIG. 6 illustrates a sample holder and machined carbon cylinders being placed within crucible of FIG. 2, according to an example of the present disclosure.

FIG. 7 illustrates the assembled sample holder, machined carbon cylinders, and crucible of FIG. 6, according to an example of the present disclosure.

FIG. 8 illustrates the assembly of FIG. 7 along with an insulating cylinder and cap, according to an example of the present disclosure.

FIG. 9 illustrates the insulating cap of FIG. 8 placed on the assembly, according to an example of the present disclosure.

FIG. 10 illustrates the assembly of FIG. 9 within a microwave radiation source in an inert gas environment, according to an example of the present disclosure.

FIG. 11 illustrates an SEM image of polyamic acid aerogel beads before carbonization, according to an example of the present disclosure.

FIG. 12 illustrates an SEM image of polyamic acid aerogel beads after carbonization, according to an example of the present disclosure.

FIG. 13 illustrates a system for carbonizing aerogel materials using a microwave radiation source, according to an example of the present disclosure.

FIG. 14 is a flow diagram illustrating formation of carbonized polyamic acid aerogel materials, according to an example of the present disclosure.

FIG. 15 provides a table listing carbon aerogel bead properties prepared by using conventional oven or by microwave irradiation.

FIG. 16 is a graph of temperature vs. time that shows an estimated temperature profile for conventional oven and for microwave reactor. Microwave temperature was estimated by apparent peak temperature and pyrometer measurement after 120 min of cooling.

FIG. 17A provides a graph of bead diameter vs. temperature (° C.).

FIG. 17B provides a graph of bead diameter vs. conventional microwave time. The time axis shows the amount of time that the heat source is applied.

FIG. 17C provides a graph that estimates temperature as a function of microwave time that relies on the information extracted from FIG. 17A and FIG. 17B.

FIG. 18 provides a graph of average bead diameters, skeletal density, porosity, BET surface area, pore diameter carbon beads that are carbonized via conventional oven and microwave radiation as a function of equivalent heat treatment temperature.

FIG. 19A shows a SEM image (100,000×) of carbon aerogel microstructure when carbonized in a conventional oven at 1050° C. for 2 hours.

FIG. 19B shows a SEM image (100,000×) of carbon aerogel microstructure when carbonized in microwave reactor for 15 min.

FIG. 20 illustrates Raman spectra of carbon aerogel beads carbonized in a microwave over under nitrogen for 10 min (circles) compared to carbon aerogels produced in a conventional oven at 1050° C. (diamonds).

FIG. 21A illustrates Raman spectra of microwave carbonized polyimide aerogels for a range of carbonization temperatures.

FIG. 21B shows Raman spectra of microwave carbonized polyimide aerogels for a range of microwave times. Microwave time is the amount of time that microwave source is applied.

FIG. 22 provides a graph of bulk density, bead diameter, skeletal density, porosity, BET surface area, and average versus heat treatment temperature of carbonized beads in conventional oven (circles) and carbonized pre-treated beads in microwave oven (squares). Beads are pre-treated in conventional oven for 2 hours at 650° C. prior to heating in a microwave oven.

### DETAILED DESCRIPTION

In the following detailed description of the technology, reference is made to the accompanying drawings, which form a part thereof, and within which are shown by way of illustration specific examples by which the technology may be practiced. It is to be understood that other examples may be utilized and structural changes may be made without departing from the scope of the technology.

### Definitions

With respect to the terms used in this disclosure, the following definitions are provided. This application will use the following terms as defined below unless the context of the text in which the term appears requires a different meaning.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In an example, the term “about” can include traditional rounding according to significant figures of the numerical value. In addition, the phrase “about ‘x’ to ‘y’” includes “about ‘x’ to about ‘y’”.

As used herein, “precursor” means a material or substance from which another material is formed. In an example, one or more precursors are placed in a sample holder and are processed using microwave radiation to form a final material or substance. In some examples, one or more precursors are combined and thermally processed using microwave radiation to form polymeric material having a framework.

Within the context of the present disclosure, the terms “framework” or “framework structure” refer to the network of interconnected oligomers, polymers, or colloidal particles that form the solid structure of a gel, an aerogel, or a xerogel. The polymeric strands or particles that make up the framework structures typically have a diameter of about 100 to 500 Ångstroms. However, framework structures of the present disclosure can also include networks of interconnected oligomers, polymers, or colloidal particles of all diameter sizes that form the solid structure within in a gel, an aerogel, or a xerogel.

As used herein, the term “aerogel” or “aerogel material” refers to a solid object, irrespective of shape or size, comprising a framework of interconnected solid building blocks, with a corresponding network of interconnected pores integrated within the framework, and containing gases such as air as a dispersed interstitial medium. As such, aerogels are open non-fluid colloidal or polymer networks that are expanded throughout their whole volume by a gas and are formed by the removal of all swelling agents from a corresponding wet-gel without substantial volume reduction or network compaction. Aerogels are generally characterized by the following physical and structural properties (according to nitrogen porosimetry testing and helium pycnometry) attributable to aerogels: (a) an average pore diameter ranging from about 2 nm to about 100 nm; (b) a porosity of at least 60% or more, and (c) a surface area of about 100 m²/g or more, such as from about 100 to about 2000 m²/g as measured by nitrogen sorption analysis. In some examples, the surface area is about 150 m²/g; 250 m²/g; 300 m²/g; 500 m²/g; 600 m²/g; 750 m²/g; 1000 m²/g; 1250 m²/g; 1500 m²/g; 1850 m²/g as measured by nitrogen sorption analysis. It can be understood that the inclusion of additives, such as a reinforcement material or an electrochemically active species, for example, silicon, may decrease porosity and the specific surface area of the resulting aerogel composite. Densification may also decrease porosity of the resulting aerogel composite. Aerogel materials of the present disclosure (e.g., polyimide and carbon aerogels) include any aerogels which satisfy the defining elements set forth in the previous paragraph.

### Methods of Forming Organic Aerogel Beads

Typically, methods for converting one chemical composition of polymeric aerogels to another, or for converting polymeric aerogels into carbon aerogels involve thermal processing. For example, high temperatures are applied to polymeric precursors for carbonization to form the framework. In other examples, heat is applied for polymer processing to imidize polyamic acid aerogels.

Additional details regarding polyimide gel/aerogel formation and other processes can be found in U.S. patent application Ser. No. 17/408,841; U.S. Patent Publication No. 2020/0269207; U.S. Pat. Nos. 7,074,880 and 7,071,287 to Rhine et al.; U.S. Pat. No. 6,399,669 to Suzuki et al.; U.S. Pat. No. 9,745,198 to Leventis et al.; Leventis et al., “Polyimide Aerogels by Ring-Opening Metathesis Polymerization (ROMP),” Chem. Mater. 2011, 23, 8, 2250-2261; Leventis et al., “Isocyanate-Derived Organic Aerogels: Polyureas, Polyimides, Polyamides,” MRS Proceedings, 1306 (2011), Mrsf10-1306-bb03-01. doi: 10.1557/opl.2011.90; Chidambareswarapattar et al., “One-step room-temperature synthesis of fibrous polyimide aerogels from anhydrides and isocyanates and conversion to isomorphic carbons,” J. Mater. Chem., 2010, 20, 9666-9678; Guo et al., “Polyimide Aerogels Cross-Linked through Amine Functionalized Polyoligomeric Silsesquioxane,” ACS Appl. Mater. Interfaces 2011, 3, 546-552; Nguyen et al., “Development of High Temperature, Flexible Polyimide Aerogels,” American Chemical Society, proceedings published 2011; Meador et al., “Mechanically Strong, Flexible Polyimide Aerogels Cross-Linked with Aromatic Triamine,” ACS Appl. Mater. Interfaces, 2012, 4 (2), pp 536-544; Meador et al., “Polyimide Aerogels with Amide Cross-Links: A Low Cost Alternative for Mechanically Strong Polymer Aerogels,” ACS Appl. Mater. Interfaces 2015, 7, 1240-1249; Pei et al., “Preparation and Characterization of Highly Cross-Linked Polyimide Aerogels Based on Polyimide Containing Trimethoxysilane Side Groups,” Langmuir 2014, 30, 13375-13383; “Microwave-induced nucleation of conducting graphitic domains on silicon carbide surfaces,” Thomas O'Loughlin, Sean Depner, Brian Schultz, Sarbajit Banerjee, Journal of Vacuum Science & Technology B 32, 011215 (2014). DOI: 10.1116/1.4861383, each of which is incorporated herein by reference in its entirety.

In conventional methods, polymeric processing (such as, for example, aerogel formation) have utilized electric furnaces to carry out reactions in the precursors. The present technology incorporates apparatus and methods that use microwave radiation to emulate the effect of electric furnaces. In particular, the apparatus and methods in accordance with the present technology do not rely on direct absorption of the microwave radiation by the material undergoing chemical transformation, but rather incorporate the use of conventional microwave ovens together with sample holders and antennas of microwave radiation to generate high temperatures that can be used to process precursors, including, for example, aerogels. The methods and apparatus can also be used to process and form other materials and other polymeric materials besides aerogels.

### Methods of Processing Material Using Microwave Radiation

Provided herein are techniques for processing of precursor materials using microwave radiation. Examples of processing in accordance with the technology, include by are not limited to, imidization and carbonization of polymeric materials, such as polyamic acid. In one example, a conventional microwave oven can be used to imidize wet gels of polyamic acid. This can provide an efficient way to convert polyamic acid to polyimide and to avoid the use of chemical imidizing agents, or energy consuming high-temperature imidization processes. According to additional examples, the same type of inexpensive microwave oven can be used not only for imidization, but also for carbonization and graphitization.

A challenge posed in directly processing organic molecules (e.g., by using longer microwave times), is that organic molecules are not good absorbers of typical microwave radiation used in inexpensive consumer-type ovens (around 2400 MHz). For example, imidization of polyamic acid has been carried out in a wet-gel state, in which microwave radiation is absorbed by the solvent (water), which is heated up. Attempting prolonged irradiation in order to increase the temperature of water further causes superheating and boiling off.

According to exemplary examples, a microwave absorbing structure, such as a carbon material, is included into the process in order to absorb microwave radiation and increase the processing temperature. In one example, the material being processed (e.g., polyamic acid particles) can be placed within a sample holder that is made of a microwave absorbing carbon material. In other examples, the material can be processed within a ceramic crucible that is itself surrounded by a microwave absorbing material. In still other examples, the material can be processed within a porous sample holder that has microwave absorbing material within the porous sample holder. One skilled in the art will recognize that additional form factors and designs can be implemented in order to place the material being processed within a cavity of a microwave absorbing material.

In the present application, many of the examples are directed to processing precursors to form aerogels, such as a polyamic aerogel bead. However, the apparatus and methods disclosed herein can be applied or adapted to process other precursors. That is, the present technology is not limited to processing precursors to form aerogels. Aerogel formation is merely illustrative of scope of use of the present technology.

In certain examples of the present disclosure, a polymer material, such as polyamic aerogel beads, can be subjected to one or more heat treatments for a duration of time of 3 hours or more, between 10 seconds and 3 hours, between 10 seconds and 2 hours, between 10 seconds and 1 hour, between 10 seconds and 45 minutes, between 10 seconds and 30 minutes, between 10 seconds and 15 minutes, between 10 seconds and 5 minutes, between 10 seconds and 1 minute, between 1 minute and 3 hours, between 1 minute and 1 hour, between 1 minute and 45 minutes, between 1 minute and 30 minutes, between 1 minute and 15 minutes, between 1 minute and 5 minutes, between 10 minutes and 3 hours, between 10 minutes and 1 hour, between 10 minutes and 45 minutes, between 10 minutes and 30 minutes, between 10 minutes and 15 minutes, between 30 minutes and 3 hours, between 30 minutes and 1 hour, between 30 minutes and 45 minutes, between 45 minutes and 3 hours, between 45 minutes and 90 minutes, between 45 minutes and 60 minutes, between 1 hour and 3 hours, between 1 hour and 2 hours, between 1 hour and 90 minutes, or in a range between any two of these values. In general, the heat treatment of the present technology is conducted via microwave radiation. Preferably, the heat treatment is performed using a conventional microwave oven.

In general, imidization can be accomplished via thermal treatment, where any suitable temperature and time range is contemplated (e.g., about 100° C.-200° C. for about 20 minutes to about 8 hours, followed by heating at about 300° C. for about 20 minutes to about 3 hours). The gelled mixture is then dried to yield a continuous porous polyimide silicon composite, where the drying can be performed using subcritical and/or supercritical carbon dioxide. Optionally, the polyimide silicon composite can be compressed, preferably uni-axially (e.g., up to 95% strain), to increase density, adjustable up to about 1.5 g/cc based on the amount of compression. In some instances, the polyimide silicon composite can be compressed to greater than about 80% strain prior to pyrolyzing the composite. Regardless of whether compression has taken place, the polyimide silicon composite is pyrolyzed to yield the continuous porous carbon silicon composite, where the resulting composite comprises greater than 0% and less than about 95% silicon by weight and comprises a porosity between about 5%-99%. In certain examples, pyrolysis can be performed at a maximum temperature of between about 750°° C. and about 1600° C., optionally with graphitization from about 1600° C. up to about 3000° C. In conventional techniques and methods, these heating steps are performed in a conventional electric-resistance heating element type furnace or a combustion heating type furnace (e.g., hydrogen or fossil fuel). Processing times mentioned do not include ramp up/down times, and labor for controlling furnace or switching furnace.

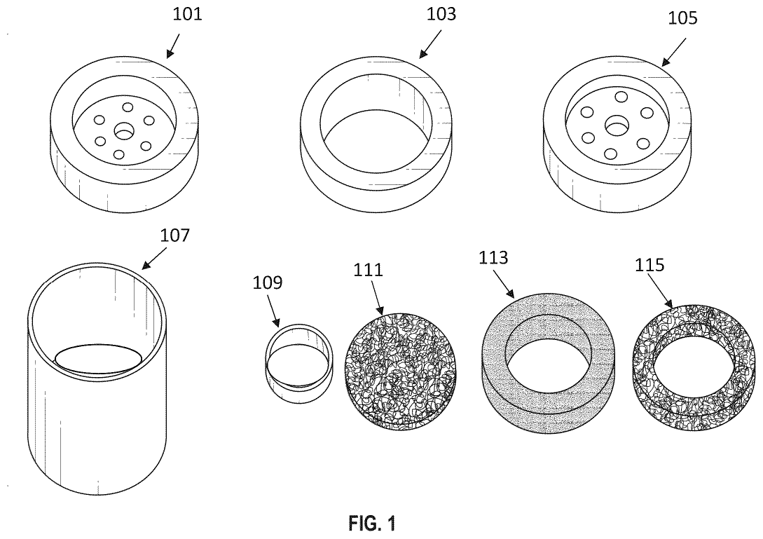

FIG. 1 illustrates a number of components for an example carbonization system, according to an example of the present disclosure in which microwave radiation is employed for precursor processing. In this example, the system can include a number of insulating segments including a base 101, a hollow cylinder 103, and a cap 105. These insulating segments can be formed of porous alumina, in some examples.

The example carbonization system shown in FIG. 1 also includes two crucibles including a crucible 107 and a sample holder 109. In some examples, the crucibles can be formed of zirconia, or some other ceramic material capable of withstanding high temperatures without reacting with the sample contained within the crucible. In alternative examples, the sample holder 109 can be formed of carbon, or some other microwave absorbing material. Each of the sample holder 109 and crucible 107 are shown to have a cylindrical structure with a closed bottom. Other formats are possible, including any format that creates a cavity (e.g., closed bottom) for securing the sample.

The example carbonization system shown in FIG. 1 also includes three carbon elements, including a machined carbon tile 111, and two machined carbon cylinders 113, 115. In an example, these carbon elements are used to substantially surround the sample holder 109 in order to absorb microwave radiation and expose the sample within the sample holder 109 to high temperatures. According to some examples, microwave radiation is absorbed deliberately by the carbon elements, rather than the sample within the sample holder. In some cases, this is done efficiently, and the carbon elements quickly reach very high temperatures that are time and energy consuming to achieve with conventional resistive furnaces. In some examples, the alumina insulating segments 101, 103, 105 can help maintain heat within the sample holder, and prevent electrical arcing.

The components illustrated in FIG. 1 are shown for example only, and the present disclosure is not limited to any particular number or geometry of carbon elements, crucibles, or insulating segments. For example, in some examples the sample holder 109 can be made of a carbon material, or some other type of microwave radiation absorbing material, such that surrounding the sample holder 109 with additional carbon elements is not necessary.

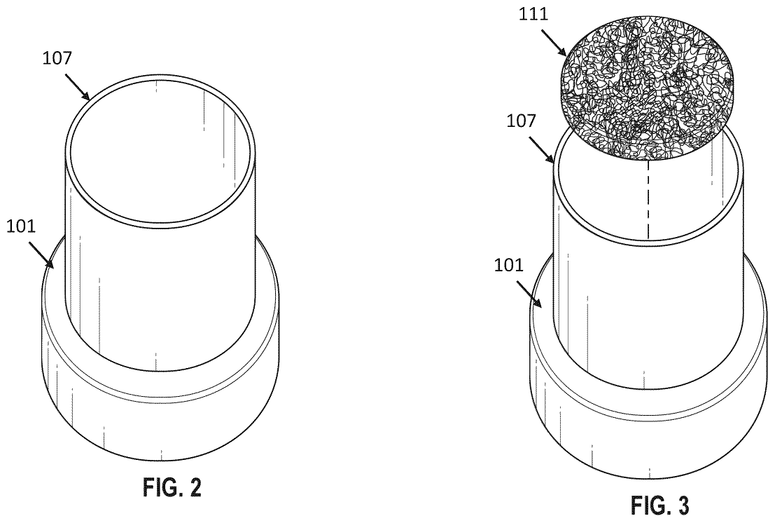

FIG. 2 illustrates an example crucible 107 within an insulating base 101, according to an example of the present disclosure. In this example, the insulating base material can be machined of porous alumina and can be machined to the proper dimensions to receive the crucible 107. In some examples, the crucible 107 can be formed of zirconia, or some other ceramic material.

FIG. 3 illustrates a machined carbon tile 111 being placed within the crucible 107 of FIG. 2, according to an example of the present disclosure. In this example, the carbon tile 111 can be machined to specifically fit within the crucible 107, and can be formed of a monolithic carbon foam material.

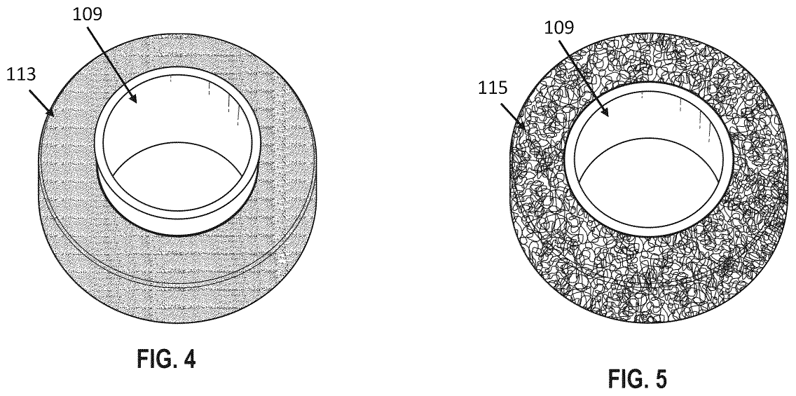

FIG. 4 illustrates a machined carbon cylinder 113 placed around a portion of a sample holder 109, or inner crucible, according to an example of the present disclosure. FIG. 5 illustrates a second machined carbon cylinder 115 placed around the sample holder 109 and above the first machined carbon cylinder 113, according to an example of the present disclosure. In this example, the two machined carbon cylinders can be formed of a monolithic carbon foam material similar to or the same as the material of the machined carbon tile 111. In some examples, the machined carbon tile 111 and cylinders 113, 115 can be formed as an integral unit rather than separate component. As discussed above, the sample holder 109 can be formed of zirconia, or some other ceramic material. In still other examples, the sample holder 109 can be formed of carbon itself. In such examples, when the sample holder 109 is a carbon crucible, it may not be necessary to surround the sample holder 109 with the machined carbon tile 111 and cylinders 113, 115.

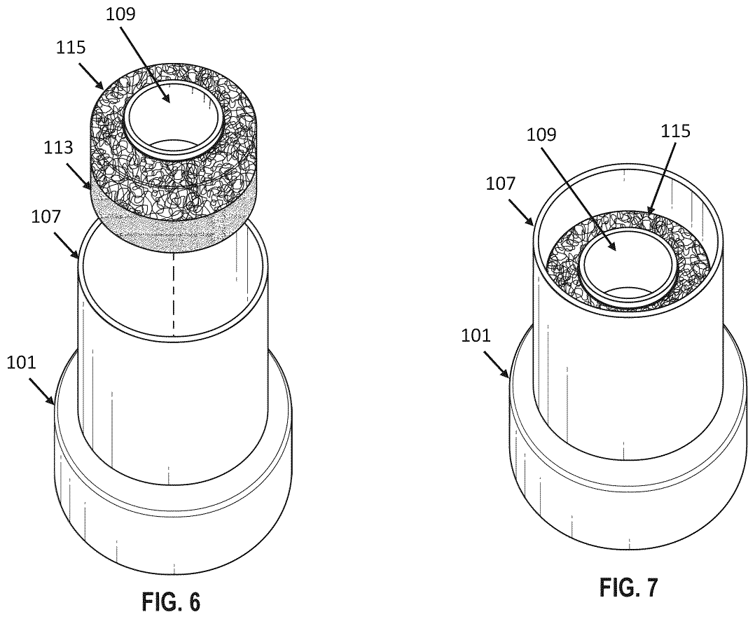

FIG. 6 illustrates the sample holder 109 and machined carbon cylinders 113, 115 being placed within the crucible 107 of FIG. 3, according to an example of the present disclosure. In this example, the sample holder 109 and machined carbon cylinders 113, 115 are placed within the crucible 107 and on top of the machined carbon tile 111, such that the sample holder 109 is surrounded on the bottom and sides by a carbon foam material that absorbs microwave radiation. It is noted, that in FIG. 6, the placement of the machined carbon cylinder of FIG. 4 with the second machined carbon cylinder of FIG. 5 are shown together about the sample holder.

FIG. 7 illustrates the assembled sample holder 109, machined carbon cylinders 113, 115, and crucible 107 of FIG. 6, according to an example of the present disclosure.

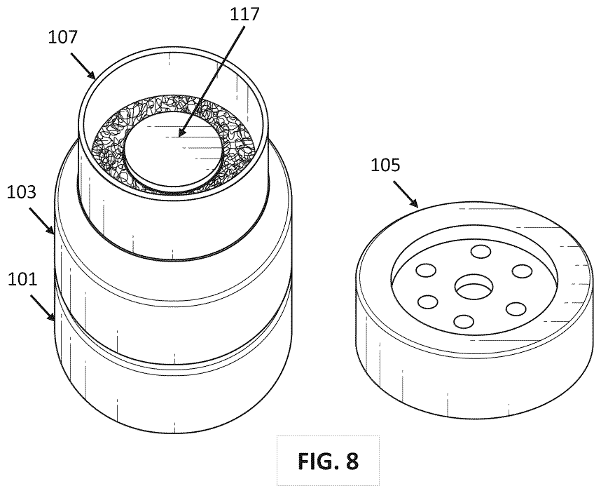

FIG. 8 illustrates the assembly of FIG. 7 along with an insulating cylinder 103 and insulating cap 105, according to an example of the present disclosure. In this example, before the insulating cap 105 is placed on top of the crucible 107, a carbon cup 117 is placed on top of the sample holder 109. Thus, the sample holder is now completely surrounded by carbon material and is housed within the crucible 107. In some examples, the insulating cylinder 103 and insulating cap 105 are formed of a porous alumina material that is the same as the insulating base 101.

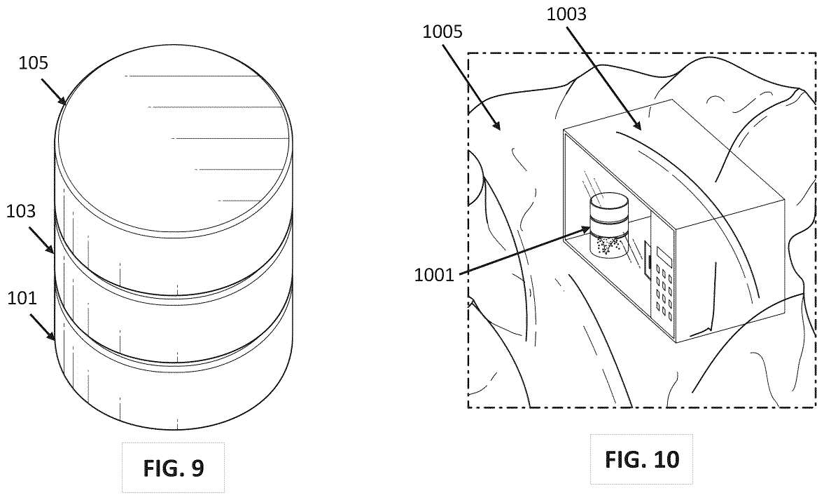

FIG. 9 illustrates the insulating cap 105 of FIG. 8 placed on the assembly, according to an example of the present disclosure. According to this example, once the insulating cap 105 is placed over the crucible 107, the entire assembly is surrounded by an insulating porous alumina. One skilled in the art will recognize that the insulating components 101, 103, 105 can be formed as fewer or more components. In some examples, an outer insulating housing can be placed over the entire assembly to provide an additional layer of insulation, if desired.

FIG. 10 illustrates the assembly 1001 of FIG. 9 within a microwave radiation source 1003 in an inert gas environment, according to an example of the present disclosure. In this example, the entire microwave radiation source 1003 is placed within an inert atmosphere within a bag or container 1005 that can hold the inert gas. The inert gas can include, for example, nitrogen. In some examples, the container 1001 is coupled to an inert gas source (such as a nitrogen gas source) in order to fill the container 1005 with the inert gas.

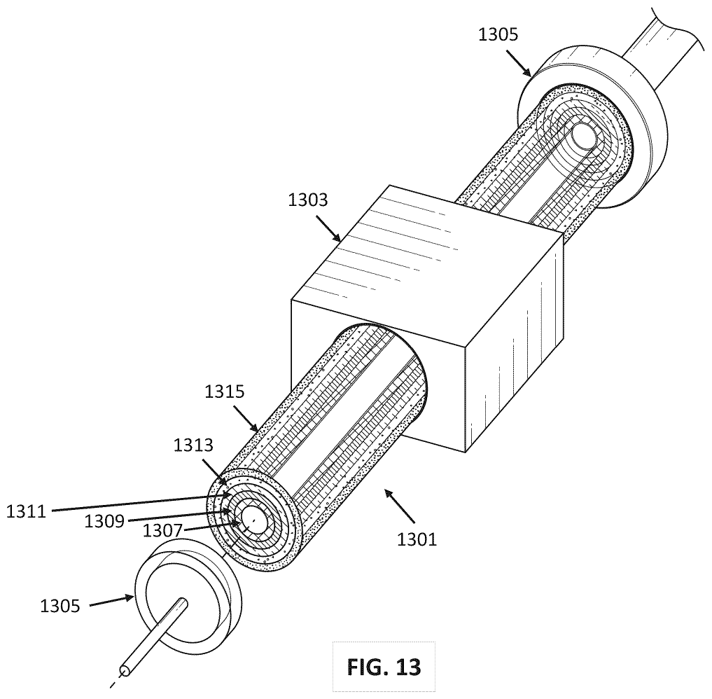

Industrial microwave ovens rely on tuning the microwave radiation to frequencies that are absorbed by specific substrates that are to be heated or react. Reaction chambers in commercial products can be evacuated and/or backfilled with inert gases, as shown in FIG. 10. According to one example, the assembly of FIG. 9 can be placed inside a commercial consumer microwave operating in an inert atmosphere, as shown in FIG. 10, and polymeric materials, such as, for example, precursors can be processed (e.g., reacted, imidized or carbonized). However, in some examples it is not necessary to place the entire microwave radiation source in an inert environment. In an alternative example, such as the example shown in FIG. 13, only the carbon tiles and the sample needs to be under an inert atmosphere or vacuum.

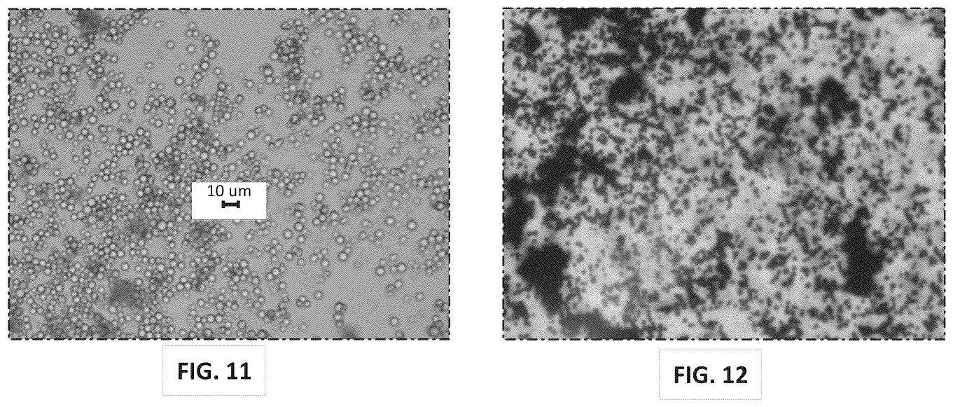

FIG. 11 illustrates an SEM image of polyamic acid aerogel beads before carbonization within microwave radiation, according to an example of the present disclosure. FIG. 12 illustrates an SEM image of polyamic acid aerogel beads after carbonization, according to an example of the present disclosure. The results shown in FIG. 12 are a 50× magnification and were achieved using the assembly disclosed above and processed within a conventional microwave oven in an inert nitrogen atmosphere. This was achieved by surrounding the polyamic acid aerogel beads with carbon foam tiles, as shown in FIGS. 4-8, which act as absorbers of microwave radiation. The carbon foam tiles absorb microwave radiation and quickly come to a desired temperature. In some examples, the carbon foam tiles may exceed a temperature of 1000° C. However, at that temperature carbon reacts with atmospheric oxygen to CO and/or CO₂. Thus, an inert atmosphere was achieved by placing the entire microwave oven in a nitrogen atmosphere.

FIG. 13 illustrates a system for carbonizing aerogel materials using a microwave radiation source 1303, according to an example of the present disclosure. As discussed above, the entire microwave radiation source does not need to be placed within an inert environment in every example. In this example, a tube furnace 1301 passes through a microwave radiation source 1303 such that the entire tube furnace 1301 does not need to be positioned entirely within the radiation source and within an inert gas environment.

In some examples, the microwave radiation source 1303 can include a consumer microwave oven, or an industrial style microwave oven. Example industrial microwave batch ovens can be found from Production Engineering, located at 1344 Woodman Drive, Dayton, OH 45432; or from Puschner Microwave Power Systems, located at Industrial Estate Neuenkirchen, Steller Heide 14, 28790 Schwanewede-Bremen, Germany.

In the example shown in FIG. 13, the tube furnace 1301 includes a number of concentric cylindrical components, including an inner ceramic tube 1307, a carbon tube 1309, a middle ceramic tube 1311, a thermal insulating layer 1313, and an outer ceramic tube 1315. The assembly shown in FIG. 13 also includes two end gaskets 1305.

In one example, the inner ceramic tube 1307, the middle ceramic tube 1311, and the outer ceramic tube 1315 can be formed of zirconia, or some other ceramic material. The inner ceramic tube 1307 includes a hollow inner portion that can hold the sample to be processed, which move from one end of the tube to another and through the microwave radiation source 1303. While the material to be processed is passing through the microwave radiation source 1303, the carbon tube 1309 can absorb microwave radiation, thus increasing the processing temperature within the microwave radiation source 1303.

In some examples, the material to be processed can pass through the tube furnace 1301 at a predetermined rate based on a desired processing time within the microwave radiation source 1303. The residence time of the materials within the microwave radiation source can be controlled, in some examples, depending on the processing procedure, process material, etc. In some examples, a gas or fluid flow passing through the tube furnace 1301 can control the residence time. In such a way, the tube configuration FIG. 13 can be modified for use in a continuous carbonization process.

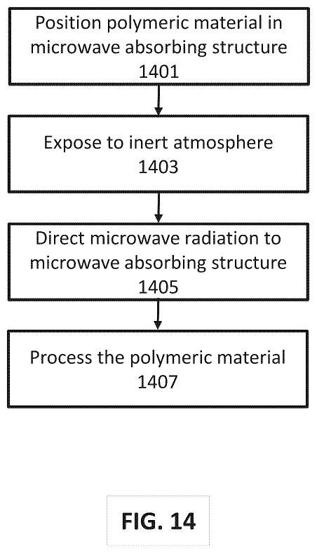

FIG. 14 is a flow diagram illustrating formation of carbonized aerogel materials, according to an example of the present disclosure. The method begins at operation 1401 with placing a polymeric material within a microwave absorbing structure. In some examples, the polymeric material includes one or more carbon precursors. In some examples, the polymeric material is in the form of an aerogel. For example, some examples feature polyamic acid aerogel particles or polybenzoxazine aerogel particles. Other examples feature a phenolic resin aerogel, an isocynate derived aerogel, a hydrocarbon aerogel, a biopolymer aerogel, and an inorganic aerogel. Other polymeric materials can be heated or processed using the apparatus and methods of the present technology. Some illustrative polymeric materials include, but are not limited to, phloroglucinol formaldehyde, resorcinol formaldehyde, phenol formaldehyde, phloroglucinol furfural, aromatized polybenzoxazine, polyureas, polyurethanes, polyimides, polyamides, polydicyclopentadiene, polyacrylonitrile, cellulose, lignin, alginate, chitosan, and proteins such as gelatin. The microwave absorbing structure can be a tubular or cylindrical structure, and can be made of a carbon foam material, in some examples. The microwave absorbing structure can also include a sample holder that is at least partially surrounded by a microwave radiation absorbing material, such as nickel oxide, silicon carbide, yttria-stabilized zirconia, iron oxide, melamine, or carbon. The sample holder may be made of ceramic or carbon, in some examples. In alternative examples, the microwave radiation absorbing material can be embedded within a thermally insulating porous ceramic, such as alumina.

At operation 1403, the microwave absorbing material is exposed to an inert atmosphere. In some examples, the method described in FIG. 14 can be implemented with the apparatus shown in FIGS. 1-9, placed in a microwave oven designed to operate under inert atmosphere conditions. In alternative examples, the method can be implemented in a flow-through tube furnace, as shown in the exemplary FIG. 13, where an inert atmosphere exists within the tube furnace.

At operation 1405, microwave radiation is directed to the microwave absorbing structure. In some examples, the microwave absorbing structure can be placed entirely within a microwave oven, or a portion of the microwave absorbing structure can pass through a microwave radiation source. In alternative examples, a microwave waveguide can be used to direct the radiation to the microwave absorbing structure. As discussed above, microwave radiation can be absorbed by the carbon elements, rather than the sample within the sample holder. In some cases, this absorption of radiation results in very high temperatures that result in thermal processing of the polymeric material within the microwave absorbing structure.

At operation 1407, the polymeric material is processed within the microwave absorbing structure. In general, processing the polymeric materials involves pyrolization the one or more polymeric materials within the microwave absorbing structure. In some examples, processing involves carbonization of the materials, such as for example carbonizing to form a carbon aerogel. This technology decrease processing times required for the production of carbonization of polymeric aerogels relative to techniques relying on electric or combustible fuel sources. Because of the significant ramp up times needed to achieve temperatures at which the materials described above carbonized, using electric/combustion furnaces comprise a bottleneck in the mass production of carbon aerogel beads. In one example, complete carbonization of polyamic acid aerogel beads using microwave techniques of the present disclosure was achieved in as little as 15 minutes. This is in contrast to electric/combustion furnaces, which may require hours to achieve the necessary temperatures within the furnace and may require even more time to complete the carbonization itself.

Other uses of this technology involve running and accelerating other organic, inorganic and sol-gel reactions including for example gelation of aqueous MTES sols. Accelerated aging, drying and pyrolysis of gels all in one system is also envisioned. Due to the high temperatures reached within the microwave absorbing structure disclosed herein, particles could also be more efficiently graphitized, in some examples.

### ILLUSTRATIVE EXAMPLES

The following examples are described for illustrative purposes only and are not intended to be limiting the scope of the current technology in any way.

### EXAMPLES

### Example 1: Imidization and Carbonization of Polyamic Acid Beads

In one example, polyamic acid (PAA) aerogel beads were imidized and carbonized using the techniques described above. Imidization was carried out by microwaving for 5 minutes and carbonization was carried out by microwaving for 15 minutes. Conventional processing for imidization (i.e., using a conventional furnace temperature of 300° C. to perform thermal imidization) was also performed as a comparison. Two sets of polyamic acid aerogel beads with different sizes, as documented in Table 1, below, were exposed to high temperatures using a microwave absorbing material and microwave radiation. Polyamic acid aerogel micro-sized beads (referred to as microbeads) were prepared using an emulsion gelation method, while polyamic acid millimeter-sized beads (referred to as millibeads) were prepared using a dripping method. Table 1 also includes data for carbon aerogel beads obtained by classic carbonization carried out thermally at 1050° C. (conventional processing).

TABLE 1

| Sample | | | Polyimide | | Surface Area |
|---|---|---|---|---|---|
| Material/ | Initial | Microwave | Bead | Microwave | of Direct |
| Process | Surface | Imidization | Surface | Carbonization | Carbonized |
| Route | Area | Time | Area | Time | Particles |
| PAA aerogel | 355 m²/g | ~5 minutes | 258 m²/g | ~15 minutes | 276 m²/g |
| microbeads/ | | | | | |
| microwave | | | | | |
| radiation | | | | | |
| PAA aerogel | 355 m²/g | — | — | — | 371 m²/g |
| microbeads/ | | | | | |
| conventional | | | | | |
| PAA aerogel | 413 m²/g | ~5 minutes | 229 m²/g | ~15 minutes | 357 m²/g |
| millibeads/ | | | | | |
| microwave | | | | | |
| radiation | | | | | |
| PAA aerogel | 413 m²/g | — | 248 m²/g | — | 391 m²/g |
| millibeads/ | | | | | |
| conventional | | | | | |

For the microwave radiation processing route, initial polyamic acid (PAA) aerogel microbeads having an average surface area of 355 m²/g were placed within a ceramic crucible surrounded by carbon foam material, as described above. This assembly was then exposed to microwave radiation within an inert nitrogen atmosphere for approximately five minutes, resulting in the imidization of the polyamic acid beads into polyimide beads. These imidized beads had an average surface area of 258 m²/g. When the assembly was exposed to microwave radiation within the inert atmosphere for approximately 15 minutes, the microbeads were carbonized, resulting in an average surface area of 276 m²/g. When similar PAA aerogel microbeads from the same batch were heated at 1050° C. under nitrogen, the resulting carbon aerogel microbeads had a surface area of 371 m²/g.

A second set of initial polyamic acid aerogel beads (referred to a millibeads) having an average surface area of 413 m²/g were placed within a ceramic crucible surrounded by carbon foam material, as described above. This assembly was then exposed to microwave radiation within an inert nitrogen atmosphere for approximately 5 minutes, resulting in the imidization of the polyamic acid millibeads into polyimide beads. These imidized particles had an average surface area of 229 m²/g. When the assembly was exposed to microwave radiation within the inert atmosphere for approximately 15 minutes, the millibeads were carbonized, resulting in an average surface area of 357 m²/g.

When another portion of the PAA aerogel millibeads from the same batch as discussed above was heated to 300° C. using a furnace (i.e., conventional process route) the resulting imidized aerogel beads had a surface area of 248 m²/g. When these PAA millibeads were heated at 1050° C. under nitrogen, the resulting carbon aerogel millibeads had a surface area of 391 m²/g.

### Example 2: Comparison of Heating Profiles of Conventional Oven (e.g., Furnace) with Conventional Microwave Oven

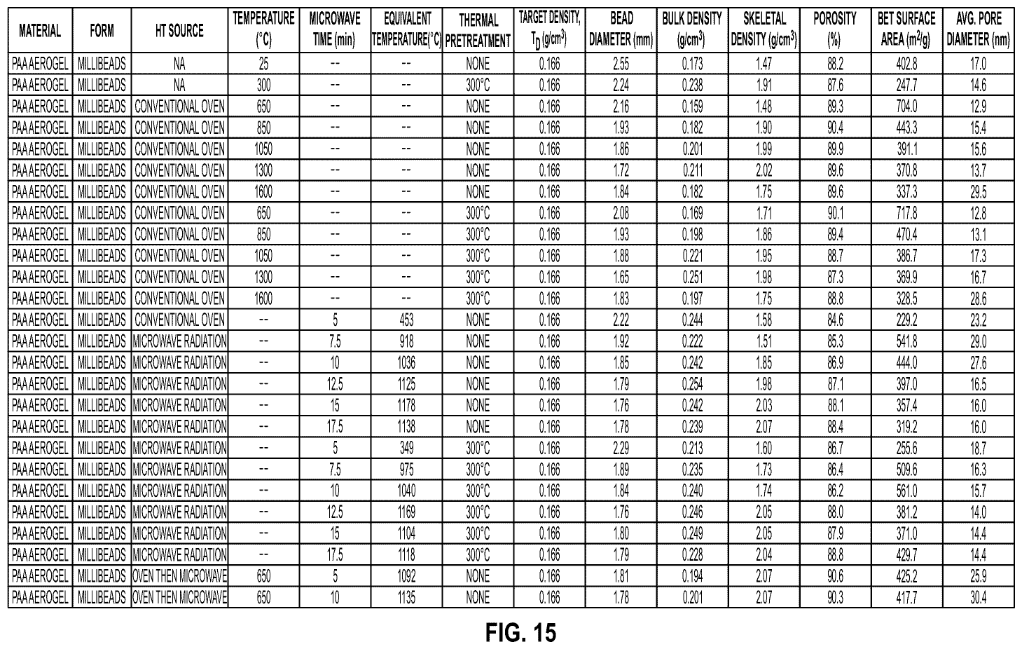

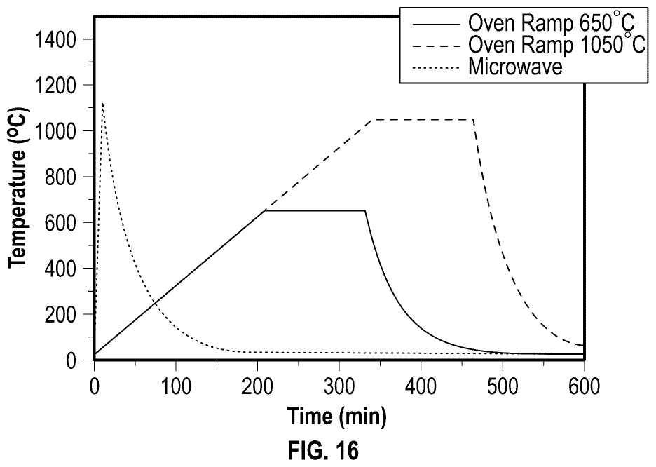

The present study revealed that carbonizing a sample via conventional microwave produces a morphology and physical properties almost equivalent to conventional thermal (furnace) carbonization. (See, FIG. 15 and example 3 below.) However, by using a conventional microwave device in accordance with the present technology results in producing a carbonized sample (i.e., a carbonized sample having substantially the same morphology and physical properties as produced in a conventional oven) in a faster way. That is, carbon material (e.g., carbon beads) prepared with microwave radiation are nearly indistinguishable from those carbonized in the conventional oven even though they are carbonized for significantly shorter times and at higher heating rates. FIG. 16 aids to understand how microwave radiation carbonizes a sample in a shorter period of time compared to conventional furnace (oven). Specifically, FIG. 16 compares a heating profile of conventional oven with microwave oven. The heating profiles of FIG. 16 illustrate a significant difference in heating rate between the two methods. While the microwave radiation method is able to reach up to 1000° C. in less than 50 minutes, the conventional oven takes approximately 6 times as long (i.e., approximately 300 minutes) to reach a similar temperature.

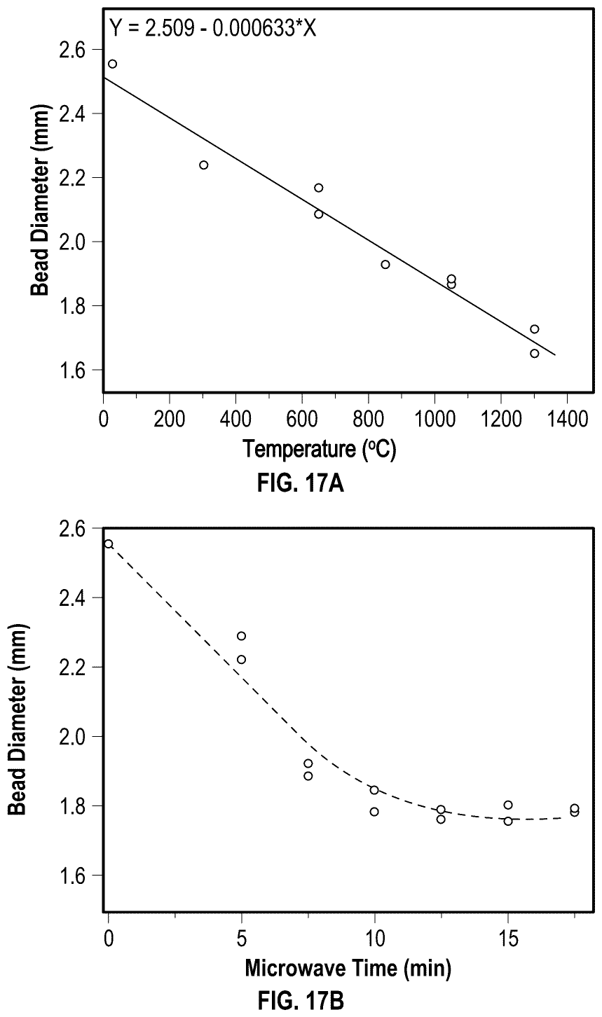

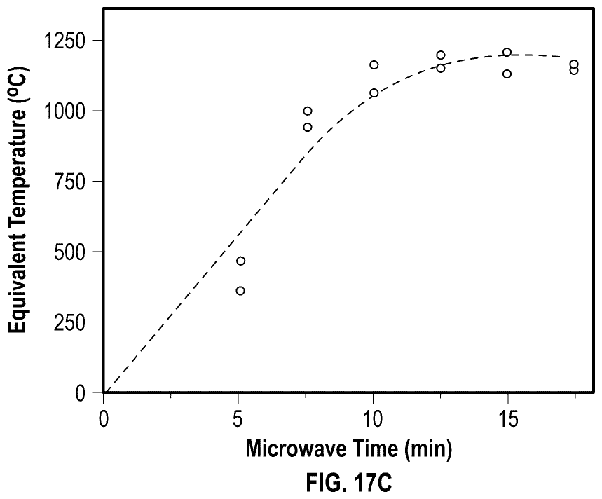

FIG. 17A and FIG. 17B show dependence of bead size on temperature (C) and microwave time, respectively. Bead sizes were used to estimate the temperature as a function of microwave time (FIG. 17C). FIG. 17C indicates that reaching temperatures up to ˜1100° C. is possible using conventional microwave radiation. It is reasonable to assume that a more powerful microwave furnace would cause a plateau at temperatures higher than 1100° C. (FIG. 17C).

### Example 3: Comparison of Carbon Aerogel Beads Properties Obtained via Conventional Oven and Conventional Microwave Oven

Carbon aerogel beads prepared from either conventional oven method or microwave radiation method resulted in similar structure with overlapping properties. Carbon aerogels produced in accordance with the present technology using a conventional microwave oven were formed in about 10 to 15 minutes.

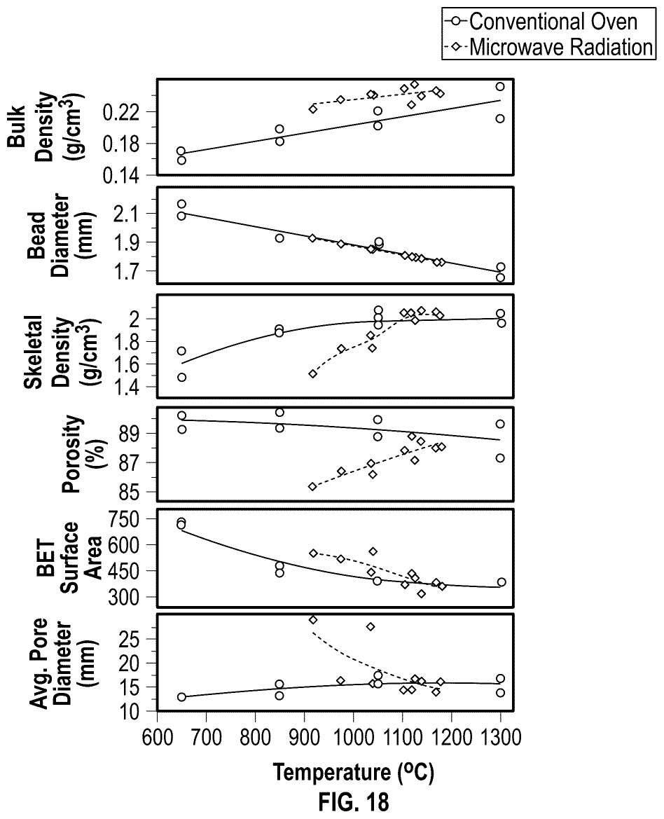

Average bead diameters, skeletal density, porosity, BET surface area, pore diameter comparison of conventional oven and microwave radiation as a function of equivalent heat treatment temperature are presented in FIG. 18. FIG. 18 shows converging aerogel properties which were achieved by microwave heating with significantly shorter carbonization time.

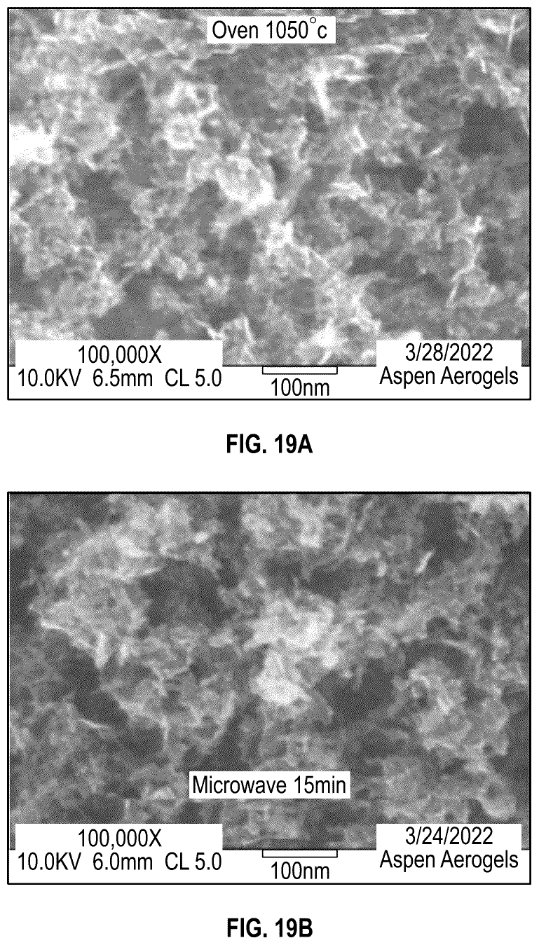

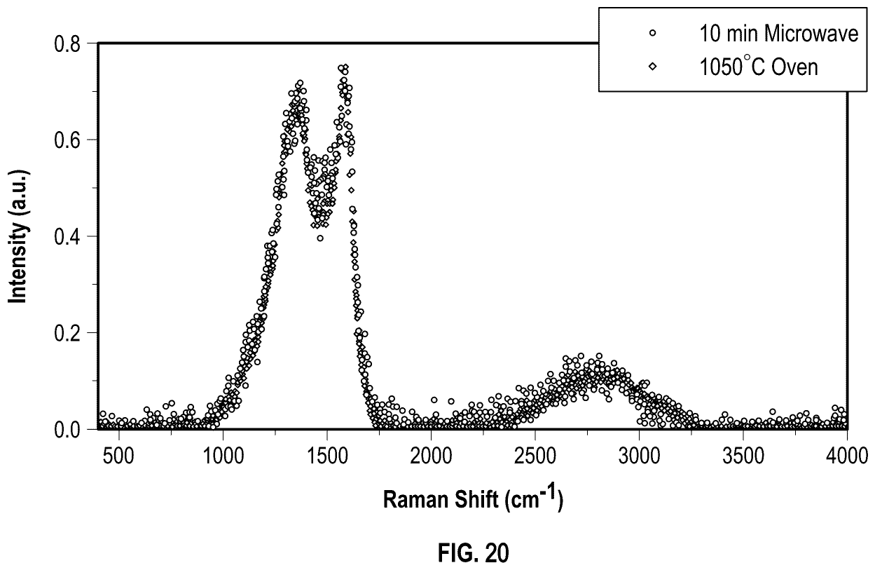

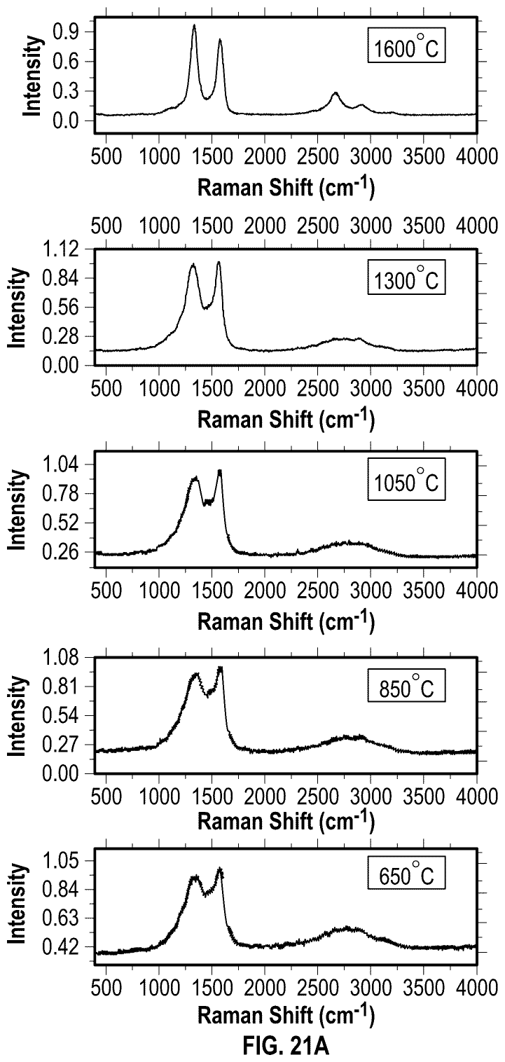

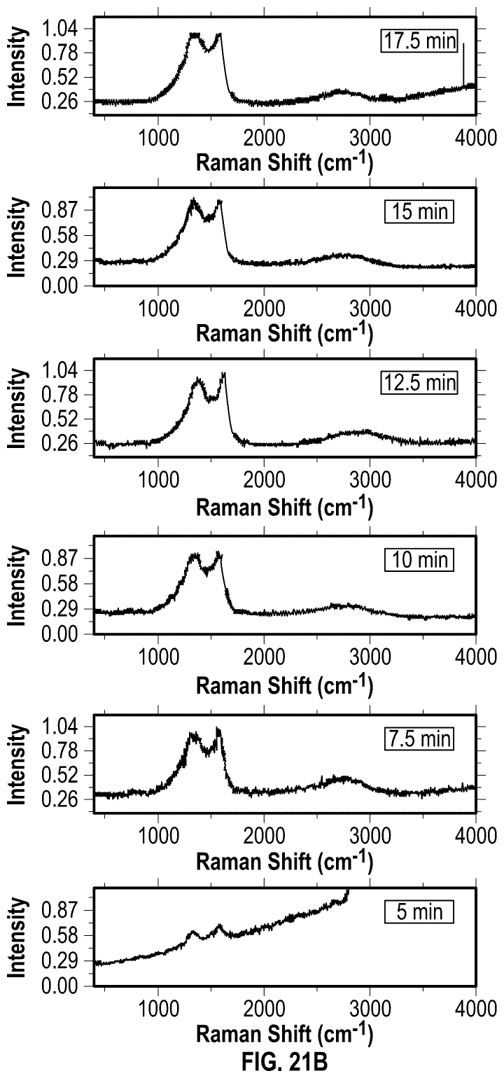

FIG. 19A and FIG. 19B show SEM images of samples carbonized by oven (e.g., furnace) and microwave, respectively. Both methods yielded similar morphology in SEM. Raman spectra of carbon aerogel beads carbonized in a microwave oven under nitrogen for 10 min was compared to carbon aerogels produced in a conventional oven at 1050° C. (FIG. 20) Largely overlapped spectra suggests similar size and ordering of graphitic domains regardless of the heating source. The peaks observed in each spectrum around 1350 cm⁻¹ and 1580 cm⁻¹ indicate the presence of disordered graphitic domains. Raman spectra of carbonized polyimide aerogels for a range of carbonization temperatures show sharpening of D (˜1350 cm⁻¹) and G (˜1580 cm⁻¹) bands with increasing oven temperature from 650° C. to 1600° C. (FIG. 21A, from bottom to top). Carbonization with varying microwave time (FIG. 21B) results in comparable spectra in alignment with spectra from 850-1050° C. Raman spectrum of polyimide beads microwaved for 5 min (FIG. 21B) indicates incomplete carbonization. Raman spectra of carbonized polyimide aerogels demonstrates further evidence that microwave process produces carbon aerogels comparable to those prepared by conventional oven.

### Example 4: Microwaving Partially Carbonized (Pre-Treated with Conventional Oven) Sample

A sample may be partially carbonized to create a microwave radiation absorbing material within the sample itself, i.e., carbon. This enables effectively applying microwave radiation to the sample without needing a separate, microwave radiation absorbing material or apparatus. In other words, by partially carbonizing a sample to create microwave radiation susceptible regions within the sample itself, a sample may be microwave-carbonized without the use of various separate components described above, such as carbon cylinders 113 and 115, carbon tile 111, carbon sample holder 109. In one experiment, this was accomplished by partially carbonizing the sample at 650° C. for two hours in a conventional oven prior to applying microwave radiation. Since carbon is a microwave susceptor (e.g., a microwave radiation absorbing material), the pre-treated sample did not require the presence of a separate carbon susceptor. Upon microwave heating of the pre-treated sample for 5 to 15 minutes, the pre-treated carbon aerogel samples change properties to resemble a sample carbonized using a conventional furnace at a temperature of around 1050° C. for 2 hours. Pre-treatment (e.g., carbonizing by furnace) allows a lower energy (lower cost) carbonization that is then improved with a short microwave treatment without any special apparatus.

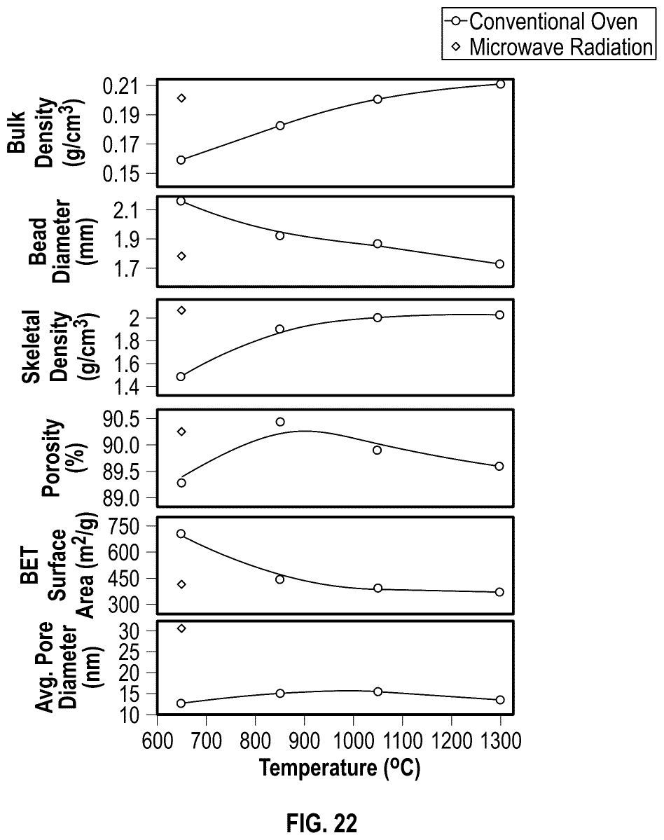

FIG. 22 compares bulk density, average bead diameters, skeletal density, porosity, BET surface area, pore diameter of samples carbonized with conventional oven vs. pre-treated samples further carbonized with microwave radiation. Each property shows the microwave heating of pre-treated samples leads to a carbonized sample (e.g., beads) similar to 1050° C. heat treatment by a conventional oven. The only notable difference between the properties of an oven-carbonized sample and a microwave-carbonized pre-treated sample is a difference in pore size. Microwave-carbonized pre-treated beads were observed to possess a larger pore size.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference should be disregarded.

The advantages set forth above, and those made apparent from the foregoing description, are efficiently attained. Since certain changes may be made in the above construction without departing from the scope of the technology, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the technology that, as a matter of language, might be said to fall there between.

What is claimed is:

1. An apparatus for heating a material, the apparatus comprising:
a microwave absorbing structure defining a processing chamber to receive the material, the microwave absorbing structure comprising a sample holder made of ceramic or carbon and at least partially surrounded by a microwave radiation absorbing material;
a microwave radiation source that generates microwave radiation in the direction of the microwave absorbing structure to thermally activate polymer processing of the material; and
an inert gas source in fluid communication with the microwave radiation source to surround the microwave absorbing structure in an inert gas atmosphere.

2. The apparatus of claim 1, wherein the microwave radiation absorbing material is made of nickel oxide, silicon carbide, yttria-stabilized zirconia, iron oxide, melamine, or carbon.

3. The apparatus of claim 1, wherein the sample holder and the microwave radiation absorbing material are embedded within a thermally insulating porous ceramic.

4. The apparatus of claim 3, wherein the thermally insulating porous ceramic is alumina.

5. The apparatus of claim 1, wherein the microwave radiation source is a conventional microwave oven.

6. The apparatus of claim 1, further comprising a microwave waveguide to direct the microwave radiation to the microwave absorbing structure.

7. The apparatus of claim 1, wherein the material to be heated comprises one or more carbon precursors.

8. A method of processing a polymeric material, the method comprising:
positioning the polymeric material within a microwave absorbing structure, the microwave absorbing structure comprising a sample holder made of ceramic or carbon and at least partially surrounded by a microwave radiation absorbing material;
directing microwave radiation from a microwave radiation source to the microwave absorbing structure to process the polymeric material; and
providing an inert gas atmosphere to the microwave absorbing structure using an inert gas source in fluid communication with the microwave radiation source.

9. The method of claim 8, wherein the microwave radiation absorbing material is made of nickel oxide, silicon carbide, yttria-stabilized zirconia, iron oxide, melamine, carbon, or mixtures thereof.

10. The method of claim 8, wherein the sample holder and the microwave radiation absorbing material are embedded within a thermally insulating enclosure.

11. The method of claim 10, wherein the thermally insulating enclosure comprises a porous ceramic.

12. The method of claim 10, wherein the thermally insulating enclosure comprises alumina.

13. The method of claim 8, wherein the microwave radiation source is a conventional microwave oven.

14. The method of claim 8, further comprising directing the microwave radiation to the microwave absorbing structure using a microwave waveguide.

15. The method of claim 8, wherein the polymeric material comprises an aerogel.

16. The method of claim 15, wherein the aerogel comprises a polyamic acid aerogel, polybenzoxazine aerogel, phenolic resin aerogel, isocyanate derived aerogel, hydrocarbon aerogel, biopolymer aerogel, or inorganic aerogel.

17. The method of claim 8, wherein processing the polymeric material comprises carbonizing the polymeric material.

18. The method of claim 8, wherein the polymeric material is partially carbonized prior to applying microwave radiation.

19. The method of claim 18, wherein the partially carbonized polymeric material is obtained by applying heat to the polymeric material in a conventional oven for a predetermined of time.

20. The method of claim 18, wherein microwave radiation from the microwave radiation source is applied for a period of time between 5 minutes and 15 minutes.
